(19) United States
(12) Patent Application Publication
(10) Pub. No.: US 2003/0088527 A1
(43) Pub. Date: May 8, 2003

(54) Methods and systems for monitoring water usage

(75) Inventors: Stephen Lan-Sun Hung, Waterford, NY (US); Timothy Mark Sivavec, Clifton Park, NY (US); James Rulon Young Rawson, Clifton Park, NY (US); Srinivas Krishnasnamy Bagepalli, Niskayuna, NY (US); Joseh Shoulian Zhu, Clifton Park, NY (US); Bang Mo Kim, Schenectady, NY (US); Frank John Mondello, Niskayuna, NY (US); Lynn Ann DeRose, Gloversville, NY (US); Joseph James Salvo, Schenectady, NY (US); Richard Blair Sheldon, Scotia, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 09/994,035

(22) Filed: Nov. 6, 2001

(51) Int. Cl. G06F 17/00

(52) U.S. Cl. 705/412

(57) ABSTRACT

Methods and systems are disclosed for determining water usage for industrial facilities and residences. One method communicates with a communications network and acquires water usage information. The water usage information is acquired in real time. The method reports water usage based upon the acquired water usage information. Another embodiment acquires water usage information over a communications network. This embodiment acquires real time water usage information over the communications network at a computer. The water usage information is associated with water use of an industrial facility. The embodiment may then display the real time water usage information via a user interface on the computer.

### BACKGROUND OF THE INVENTION

This invention generally relates to water use management and, more particularly, to methods and systems for monitoring and for predicting water usage in industrial, commercial, and residential facilities.

Water is used throughout industrial and commercial facilities and residences. Industrial facilities, for example, use water for many applications, such as a solvent for cleaning equipment and facilities, as a carrier for raw materials, intermediates, and products, as the raw material itself, as a cooling medium, and as a component for generating steam. Treated water can be used to clean electronic equipment and circuit boards. High-pressure water can cut metals and other materials. Water is also used to maintain landscaping. Residences use water for landscaping, cleaning, and cooking. Water is, in short, widely used in the home and throughout industry.

Although water is so widely used, few industries and few homeowners make real efforts to monitor and to conserve water usage. While water usage, and water treatment, can be a significant operating cost, most industries simply consider water usage as a fixed cost. Although industrial plants employ many people to reduce the usage of raw materials and to reduce the production of scrap, few plants actively monitor water usage. Homeowners, similarly, rarely have user-friendly equipment, or the initiative, to monitor daily water usage. Industrial facilities, and homeowners, therefore, often make only very limited efforts to monitor and to minimize water usage.

There is, accordingly, a need in the art for methods and systems of monitoring water usage, for methods and systems of predicting water use, for methods and systems of quickly gathering, formatting, and reporting water usage data to governmental entities, for methods and systems that easily and inexpensively monitor water usage, and for methods and systems that facilitate sharing water usage data.

### BRIEF SUMMARY OF THE INVENTION

One embodiment includes a method of monitoring water usage from industrial and residential facilities. The method communicates with a communications network and acquires water usage information. The water usage information is acquired in real time or in near-real-time. The method may then report water usage based upon the acquired water usage information.

Another embodiment describes a method of monitoring water usage at an industrial facility. This embodiment communicates with a communications network and acquires water usage information. The water usage information is acquired in real time or in near-real-time. Water usage for the industrial facility is reported along the communications network, with the water usage based upon the acquired water usage information.

A further embodiment describes a method of acquiring water usage information over a communications network. This further embodiment acquires water usage information over the communications network at a computer. The water usage information is associated with water use of an industrial facility. The method displays the water usage information via a user interface on the computer.

A remote water monitoring system for an industrial process is also disclosed. The system has a water system flowing water along the industrial process, at least one monitor, and a communications network. The at least one monitor is for monitoring water flowing along the water system, and the monitor generates water usage information. The communications network acquires the water usage information, and the communications network communicates the water usage information in real time.

Still another remote water monitoring system for an industrial process is disclosed. This system has a water system flowing water along the industrial process, at least one monitor, and a communications network. The water system may have at least one water main receiving water from a water supply. The at least one monitor is for monitoring water flowing along the water system. The at least one monitor generates water usage information. The communications network acquires the water usage information, and the communications network communicates in real time the water usage information to at least one computer coupled to the communications network.

A system configured for monitoring water usage by an industrial process is disclosed. The system has a Water Monitoring Module, a memory storage device, and a processor. The Water Monitoring Module acquires water usage information, with the water usage information associated with water used by the industrial process. The memory storage device stores the acquired water usage information. The processor calculates water usage for the industrial process based upon the acquired water usage information.

### BRIEF DESCRIPTION OF THE DRAWINGS

FIG. 1 is a block diagram showing a Water Monitoring Module residing in a computer system;

FIG. 2 is a block diagram of a communications network further representing an operating environment for the Water Monitoring Module;

FIG. 3 is a block diagram describing one embodiment of the Water Monitoring Module;

FIGS. 4-6 are flowcharts of a method of monitoring water usage at an industrial facility;

FIG. 7 is a flowchart of a method of acquiring water usage information over a communications network;

FIG. 8 is a schematic diagram of a remote water monitoring system for an industrial process; and

FIG. 9 is a schematic representing a user interface for displaying water usage information.

### DETAILED DESCRIPTION OF THE INVENTION

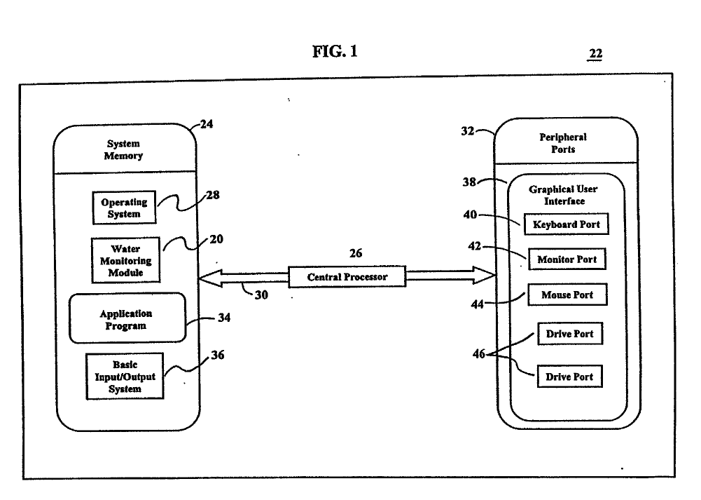

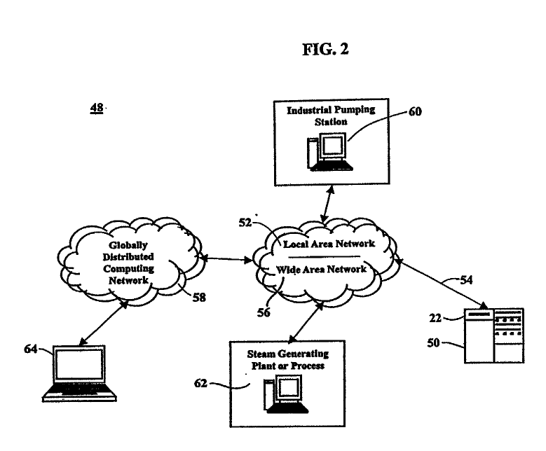

FIGS. 1 and 2 depict a possible computer operating environment for an embodiment of the present invention. This embodiment of an Water Monitoring Module 20 comprises a computer program that acquires information and predicts water usage. As those skilled in the art of computer programming recognize, computer programs are depicted as process and symbolic representations of computer operations. Computer components, such as a central processor, memory devices, and display devices, execute these computer operations. The computer operations include manipulation of data bits by the central processor, and the memory devices maintain the data bits in data structures. The process and symbolic representations are understood, by those skilled in the art of computer programming, to convey the discoveries in the art.

FIG. 1 is a block diagram showing the Water Monitoring Module 20 residing in a computer system 22. The Water Monitoring Module 20 may be stored within a system memory device 24. The computer system 22 also has a central processor 26 executing an operating system 28. The operating system 28 also resides within the system memory device 24. The operating system 28 has a set of instructions that control the internal functions of the computer system 22. A system bus 30 communicates signals, such as data signals, control signals, and address signals, between the central processor 26, the system memory device 24, and at least one peripheral port 32. Those of ordinary in the art understand that the program, processes, methods, and systems described in this patent are not limited to any particular computer system or computer hardware.

Those skilled in art also understand the central processor 26 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other microprocessor manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). While only one microprocessor is shown, those skilled in the art also recognize multiple processors may be utilized. Those skilled in the art further understand that the program, processes, methods, and systems described in this patent are not limited to any particular manufacturer's central processor.

The system memory 24 also contains an application program 34 and a Basic Input/Output System (BIOS) program 36. The application program 34 cooperates with the operating system 28 and with the at least one peripheral port 32 to provide a Graphical User Interface (GUI) 38. The Graphical User Interface 38 is typically a combination of signals communicated along a keyboard port 40, a monitor port 42, a mouse port 44, and one or more drive ports 46. The Basic Input/Output System 36, as is well known in the art, interprets requests from the operating system 28. The Basic Input/Output System 36 then interfaces with the keyboard port 40, the monitor port 42, the mouse port 44, and the drive ports 46 to execute the request.

The operating system 28 may be WINDOWS® (WINDOWS® is a registered trademark of Microsoft Corporation, One Microsoft Way, Redmond Wash. 98052-6399, 425.882.8080, www.Microsoft.com). WINDOWS® is typically preinstalled in the system memory device 24. Those of ordinary skill in the art also recognize many other operating systems are suitable, such as UNIX® (UNIX® is a registered trademark of the Open Source Group, www.opensource.org), Linux, and Mac® OS (Mac® is a registered trademark of Apple Computer, Inc., 1 Infinite Loop, Cupertino, Calif. 95014, 408.996.1010, www.apple.com). Those skilled in the art again understand that the program, processes, methods, and systems described in this patent are not limited to any particular operating system.

FIG. 2 is a block diagram of a communications network 48. This communications network 48 further represents an operating environment for the Water Monitoring Module (shown as reference numeral 20 in FIG. 1). The Water Monitoring Module resides within the memory storage device (shown as reference numeral 24 in FIG. 1) in the computer system 22. The computer system 22 is shown as a server 50. The server 50 may communicate with a Local Area Network (LAN) 52 along one or more data communication lines 54. As those of ordinary skill understand, the Local Area Network 52 is a grid of communication lines through which information is shared between multiple nodes. These multiple nodes are conventionally described as network computers. As those of ordinary skill in the art also recognize, the Local Area Network 52 may itself communicate with a Wide Area Network (WAN) 56 and with a globally-distributed computing network 58 (the “Internet”). The communications network 48 allows the server 50 to request and acquire information from many other computers connected to the Local Area Network 52, the Wide Area Network 56, and the globally-distributed computing network 58.

As FIG. 2 shows, the server 50 may communicate/acquire information to/from many computers connected to the communications network 48. The server 50, for example, may acquire water usage information from a pump station computer 60. The pump station computer 60, or other metering device, monitors an industrial pumping station. The pump station computer 60, for example, monitors water pressure and water flow into the industrial pumping station. The server 50 could also acquire water usage information from a steam process computer 62, or other metering device, monitoring a steam generating plant or process. The steam process computer 62, for example, monitors the water used to produce steam. FIG. 2 also shows that remote users may use a remote computer 64 to access the communications network 48 and to remotely access the server 50, the pump station computer 60, and the steam process computer 62. Data encryption and/or user verification would help ensure the shared information remains confidential. Because many computers may be connected to the communications network 48, computers and computer users may share and communicate a vast amount of information acquired and processed by the Water Monitoring Module. The Water Monitoring Module thus permits on-line, real-time water usage monitoring.

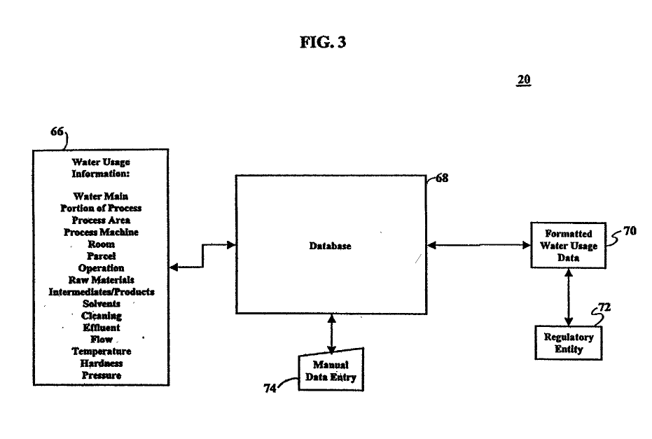

FIG. 3 is a block diagram describing one embodiment of the Water Monitoring Module 20. The Water Monitoring Module 20 acquires information from the communications network (shown as reference numeral 48 in FIG. 2) and uses this information to track and predict water usage for residences and for industrial facilities. As FIG. 3 illustrates, the Water Monitoring Module 20 acquires water usage information 66 and stores this information in a database 68. The water usage information 66 may be water flowing along a water main into an industrial plant (water flowing into the plant “gate”) or into a residence. The water usage information 66 could also include water flowing to any portion, area, or machine of an industrial process. The water usage information 66, likewise, could include water flowing to a particular room/area of a residence or parcel/field/operation of a farm. The water usage information 66 may include water used to carry raw materials, water used to carry intermediates or products, water used to carry solvents, water used as a solvent, or water used for cleaning. The water usage information 66 may represent any water used in a residence or an industrial process. The Water Monitoring Module 20 may acquire this water usage information 66 from multiple locations, and this water usage information 66 is used to track and to predict historical, present, and future water usage from those multiple locations. The Water Monitoring Module 20 could build a water use model based upon historical water use to monitor the efficiency of present water use and to predict future water use. The Water Monitoring Module 20 thus supplies water usage profiles that help plant operators, homeowners, farmers and others to understand the consequences of excess water usage. Sub-metering could also be used to meter water returned or recycled from a process.

The Water Monitoring Module 20 may also report water usage data to governmental entities. As FIG. 3 shows, the Water Monitoring Module 20 may communicate with a regulatory agency, or with a utility, to send and receive statements, usage reports, water quality reports, and other water-related information. The Water Monitoring Module 20 could thus format the acquired water usage information 66 to the reporting requirements of, for example, the Environmental Protection Agency, a state water quality agency, or a state/municipal water service. The Water Monitoring Module 20 may communicate formatted water usage data 70 along the communications network, in real-time and on-line, to a regulatory entity 72. The Water Monitoring Module 20 may even accept manually-entered data 74 from plant operators, engineers, and others with access to the database 68 or with access to the network. Data encryption and/or user verification would help ensure the shared information remains confidential. The Water Monitoring Module 20 thus reduces, and could even eliminate, the need for plant personnel to monitor and to report water usage information.

The Water Monitoring Module 20 also improves water management programs. Because multiple locations can be tracked, the Water Monitoring Module 20 allows engineers to monitor and to characterize variations in water usage between different operations and between different plants. The Water Monitoring Module 20 thus helps identify and share the best water management practices. Because the Water Monitoring Module 20 provides a real-time measurement of water usage, dispersed plant locations can be monitored on-line from a central location. The Water Monitoring Module 20 may also provide actual water usage data for utility rate negotiations. The Water Monitoring Module 20, in addition, allows plant operators to forecast water use based upon production targets. Because the Water Monitoring Module 20 maintains a database of water usage data, this water usage data can be modeled to production measurements. Plant operators can thus forecast future water requirements based upon past data and production goals. Plant operators could also benchmark water usage against transfer function predictions.

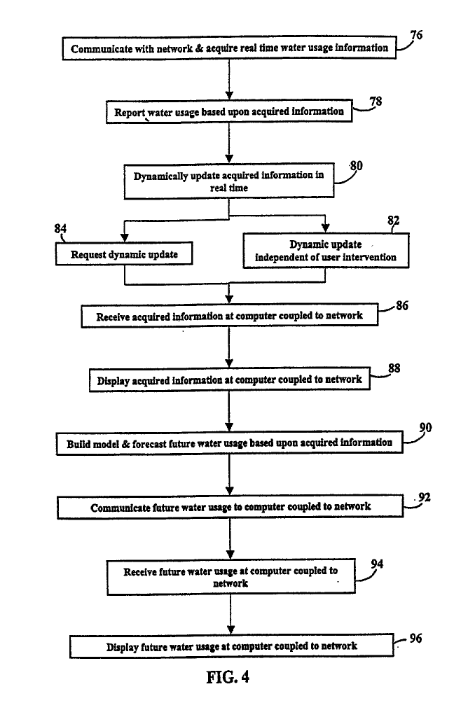

FIGS. 4-6 are flowcharts of a method of monitoring water usage at an industrial facility. The method communicates with a communications network and acquires water usage information, with the water usage information acquired in real time (Block 76). Water usage for the industrial facility is reported along the communications network (Block 78). The acquired water usage information may be dynamically updated in real time (Block 80), independent of any intervention by a human user (Block 82), or by request (Block 84). The acquired water usage information may be received (Block 86) and displayed (Block 88) at at least one computer coupled to the communications network. A model is built to predict future water usage based upon the acquired water usage information (Block 90). Predicted future water usage may be communicated (Block 92), received (Block 94), and displayed (Block 96) at at least one computer coupled to the communications network.

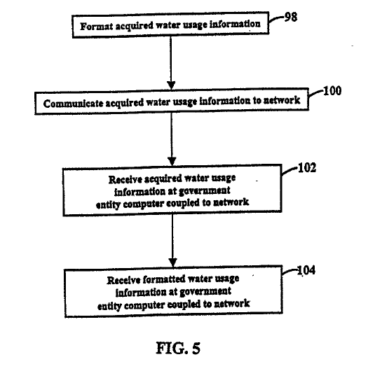

FIG. 5 shows the method may communicate with a regulatory entity. The acquired water usage information may be encrypted and formatted to the requirements of a regulatory entity (Block 98) and communicated to at least one computer coupled to the communications network (Block 100). The acquired water usage information (Block 102) or the formatted water usage information (Block 104) could be received at a government entity, the government entity having at least one computer coupled to the communications network and receiving the acquired/formatted water usage information.

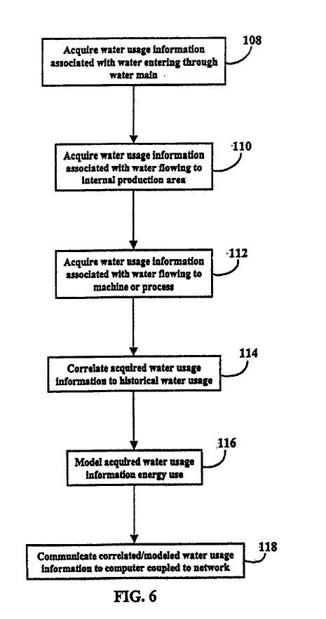

FIG. 6 shows the method may aid in managerial analysis of water usage trends. The acquired water usage information may be associated with water entering the industrial facility through at least one water main (Block 108), water flowing to an internal production area within the industrial facility (Block 110), and water flowing to a machine/process (Block 112). The acquired water usage information may be correlated to historical water usage (Block 114). A model is then built to model energy use from the acquired water usage information (Block 116). Correlated or modeled information may be communicated to at least one computer coupled to the communications network (Block 118).

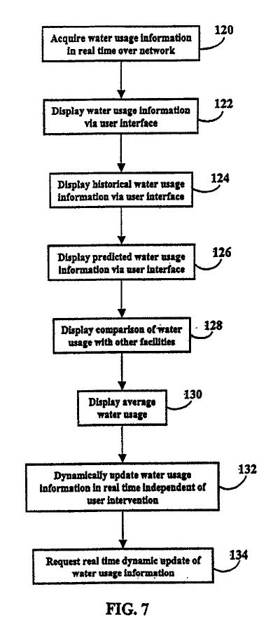

FIG. 7 is a flowchart of a method of acquiring water usage information over a communications network. Water usage information is acquired in real time over the communications network at a computer, with the water usage information associated with water use of an industrial facility (Block 120). The real time water usage information may be displayed via a user interface on the computer (Block 122). Historical water use (Block 124) and predicted water use (Block 126) for the industrial facility may be displayed via the user interface. A comparison between water used at the industrial facility and a benchmark, such as water used at a different industrial facility, may also be displayed (Block 128). Average water use for the industrial facility could also be displayed (Block 130). This method may also dynamically update the acquired water usage information in real time, independent of any intervention by a human user (Block 132). The method may also request a dynamic update of the acquired water usage information in real time (Block 134).

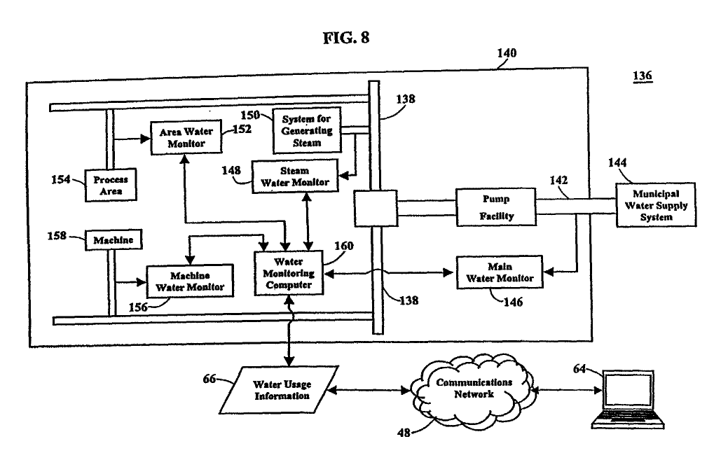

FIG. 8 is a schematic diagram of a remote water monitoring system 136 for an industrial process 140. The remote water monitoring system 136 includes a water system 138 serving the industrial process 140. The water system 138 flows water along the industrial process 140, and the water system 138 has at least one water main 142 receiving water from a water supply 144. Although the water supply 144 is shown as a municipal water supply system, the water supply 144 is not so limited and could be any source of water. At least one monitor monitors water flowing along the water system 138 and generates the water usage information 66. The communications network 48 acquires the water usage information 66, and the communications network 48 communicates the water usage information 66 in real time to the at least one network computer 64 coupled to the communications network 48. As FIG. 6 shows, the at least one monitor may include a main water monitor 146 for monitoring water flowing along the water main 142, a steam water monitor 148 for monitoring water flowing to a system 150 for generating steam, an area water monitor 152 for monitoring water flowing to an area 154 within the industrial process 140, and a machine water monitor 156 for monitoring water flowing to machine 158 within with industrial process 140. The term “monitor” includes mechanical meters, sensors, and other measuring/metering devices, yet, the term “monitor” also includes any analog-to-digital conversion devices or other electrical enhancements that enable the measuring/metering device to acquire and to share the water usage information 66 along the communications network 48. See, e.g., THE AMERICAN HERITAGE DICTIONARY 810 (1991). The communications network 48, therefore, acquires the water usage information 66 from at least one water monitoring computer 160, and the water usage information 66 is communicated along the communications network 48.

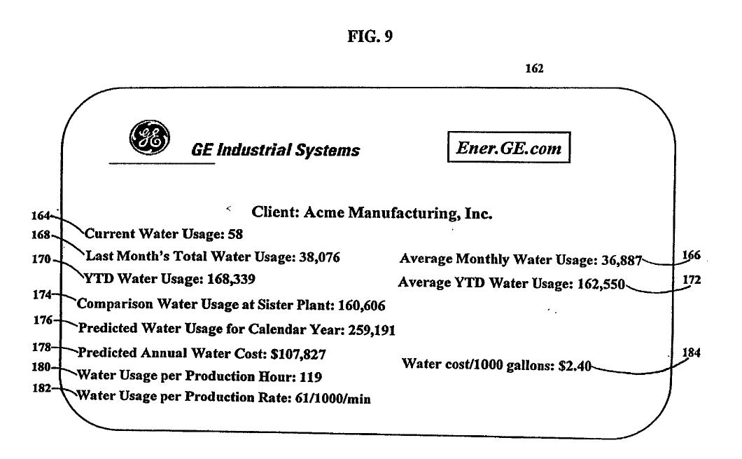

FIG. 9 is a schematic representing a user interface 160 for displaying the water usage information (shown as reference numeral 66 in FIG. 3). The user interface 160 may display a various indications of water usage. The user interface 160, for example, may display, but is not limited to, current water usage 162, average monthly water use 164, and the previous month's water use 166. The user interface 160 may display year-to-date water usage 168 and average year-to-date water usage 170. A sister plant's water usage 172 could be shown, as well as predicted water usage 174 and predicted water costs 176. Efficiency targets could also be displayed, such as water usage per production hour 178 and water usage per production rate 180. Even current pricing information, such as current cost per gallon 182, could be included. Many other indications of past, current, future, and competitive water usage could also be displayed.

The Water Monitoring Module (shown as reference numeral 20 in FIG. 1) may be physically embodied on or in a computer-readable medium. This computer-readable medium may be CD-ROM, DVD, tape, cassette, floppy disk, memory card, and a large-capacity disk (such as IOMEGA® ZIP®, JAZZ®, and other large-capacity memory products) (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer readable media, and other types not mentioned here but considered within the scope of the present invention, allow the Water Monitoring Module to be easily disseminated. A computer program product for tracking, monitoring, and reporting water usage comprises a computer-readable medium and the Water Monitoring Module. The Water Monitoring Module is stored on the medium, and the Water Monitoring Module monitors water usage at residential and industrial facilities. The Water Monitoring Module communicates water usage information over a communication network. While FIG. 9 shows a user interface for an industrial facility, similar water usage information could be displayed in a user interface for residences.

While the present invention has been described with respect to various features, aspects, and embodiments, those of ordinary skill in the art, and those unskilled, will recognize the invention is not so limited. Other variations, modifications, and alternative embodiments may be made without departing from the spirit and scope of the present invention.

What is claimed is:

1 A method of monitoring water usage from industrial and residential facilities, comprising:
communicating with a communications network and acquiring water usage information, the water usage information acquired in real time; and
reporting water usage based upon the acquired water usage information.

2 A method of monitoring water usage according to claim 1, further comprising displaying the acquired water usage information.

3 A method of monitoring water usage according to claim 1, further comprising predicting future water usage based upon the acquired water usage information.

4 A method of monitoring water usage according to claim 1, further comprising communicating predicted future water usage information to at least one computer coupled to the communications network, the predicted water usage information based upon the acquired water usage information.

5 A method of monitoring water usage according to claim 1, further comprising formatting the acquired water usage information to the requirements of a regulatory agency.

6 A method of monitoring water usage according to claim 5, further comprising communicating formatted water usage information to at least one computer coupled to the communications network.

7 A method of monitoring water usage according to claim 5, further comprising communicating formatted water usage information to a regulatory agency.

8 A method of monitoring water usage according to claim 1, further comprising comparing the acquired water usage information to historical water usage information.

9 A method of monitoring water usage according to claim 1, further comprising communicating historical water usage information to at least one computer coupled to the communications network.

10 A method of monitoring water usage at an industrial facility, comprising:
communicating with a communications network and acquiring water usage information, the water usage information acquired in real time; and
reporting water usage for the industrial facility along the communications network, the water usage based upon the acquired water usage information.

11 A method of monitoring water usage according to claim 10, further comprising dynamically updating the acquired water usage information in real time.

12 A method of monitoring water usage according to claim 10, further comprising dynamically updating the acquired water usage information in real time independent of any intervention by a human user.

13 A method of monitoring water usage according to claim 10, further comprising requesting a dynamic update of the acquired water usage information in real time.

14 A method of monitoring water usage according to claim 10, further comprising receiving the acquired water usage information at at least one computer coupled to the communications network.

15 A method of monitoring water usage according to claim 10, further comprising displaying the acquired water usage information on at least one computer coupled to the communications network.

16 A method of monitoring water usage according to claim 10, further comprising predicting future water usage based upon the acquired water usage information.

17 A method of monitoring water usage according to claim 10, further comprising communicating predicted future water usage along the communications network, the predicted future water usage based upon the acquired water usage information.

18 A method of monitoring water usage according to claim 10, further comprising receiving predicted future water usage at at least one computer coupled to the communications network, the predicted future water usage based upon the acquired water usage information.

19 A method of monitoring water usage according to claim 10, further comprising displaying predicted future water usage on at least one computer coupled to the communications network, the predicted future water usage based upon the acquired water usage information.

20 A method of monitoring water usage according to claim 10, further comprising formatting the acquired water usage information to the requirements of a regulatory agency.

21 A method of monitoring water usage according to claim 10, further comprising communicating formatted water usage information along the communications network to at least one computer coupled to the communications network.

22 A method of monitoring water usage according to claim 10, further comprising receiving formatted water usage information at at least one computer coupled to the communications network.

23 A method of monitoring water usage according to claim 10, further comprising receiving the acquired water usage information at a government entity, the government entity having at least one computer coupled to the communications network and receiving the acquired water usage information.

24 A method of monitoring water usage according to claim 10, further comprising receiving formatted water usage information at a government entity, the government entity having at least one computer coupled to the communications network and receiving the formatted water usage information.

25 A method of monitoring water usage according to claim 10, further comprising receiving formatted water usage information at a government entity, the government entity having at least one computer coupled to the communications network and receiving the formatted water usage information, the formatted water usage information based upon the acquired water usage information and formatted to the requirements of the government entity.

26 A method of monitoring water usage according to claim 10, further comprising correlating the acquired water usage information to energy usage of the industrial facility.

27 A method of monitoring water usage according to claim 10, further comprising comparing the acquired water usage information to historical water usage information.

28 A method of monitoring water usage according to claim 10, further comprising communicating historical water usage information to at least one computer coupled to the communications network.

29 A method of monitoring water usage according to claim 10, wherein acquiring the water usage information comprises acquiring water usage information associated with water flowing into the industrial facility.

30 A method of monitoring water usage according to claim 10, wherein acquiring the water usage information comprises acquiring water usage information associated with water flowing to an internal production area within the industrial facility.

31 A method of monitoring water usage according to claim 10, wherein acquiring the water usage information comprises acquiring water usage information associated with water flowing to at least one sub-process within the industrial facility.

32 A method of monitoring water usage according to claim 10, wherein acquiring the water usage information comprises acquiring water usage information associated with water flowing to at least one process within the industrial facility.

33 A method of acquiring water usage information over a communications network, comprising:
acquiring real time water usage information over the communications network at a computer, the water usage information associated with water use of an industrial facility; and
displaying the real time water usage information via a user interface on the computer.

34 A method of acquiring water usage information according to claim 33, further comprising displaying historical water usage for the industrial facility via the user interface.

35 A method of acquiring water usage information according to claim 33, further comprising displaying predicted future water use, the predicted water use based upon the acquired water usage information.

36 A method of acquiring water usage information according to claim 33, further comprising displaying a comparison between water used at the industrial facility and water used at a different industrial facility.

37 A method of acquiring water usage information according to claim 33, further comprising displaying average water use for the industrial facility.

38 A method of acquiring water usage information according to claim 33, further comprising dynamically updating the acquired water usage information in real time independent of any intervention by a human user.

39 A method of monitoring water usage according to claim 33, further comprising requesting a dynamic update of the acquired water usage information in real time.

40 A remote water monitoring system for an industrial process, comprising:
a water system flowing water along the industrial process;
at least one monitor for monitoring water flowing along the water system, the monitor generating water usage information; and
a communications network acquiring the water usage information, the communications network communicating in real time the water usage information.

41 A remote water monitoring system according to claim 40, wherein the at least one monitor monitors water flow rate along the water system.

42 A remote water monitoring system according to claim 40, further comprising at least one computer system communicating with the communications network, the at least one computer system receiving the water usage information.

43 A remote water monitoring system according to claim 42, wherein the at least one computer comprises a user interface displaying the water usage information.

44 A remote water monitoring system for an industrial process, comprising:
a water system flowing water along the industrial process, the water system comprising at least one water main receiving water from a water supply;
at least one monitor for monitoring water flowing along the water system, the at least one monitor generating water usage information; and
a communications network acquiring the water usage information, the communications network communicating in real time the water usage information to at least one computer coupled to the communications network.

45 A remote water monitoring system according to claim 44, wherein the at least one monitor comprises a main water monitor for monitoring water flowing along the water main.

46 A remote water monitoring system according to claim 44, wherein the at least one monitor comprises a steam water monitor for monitoring water flowing to a system for generating steam.

47 A remote water monitoring system according to claim 44, wherein the at least one monitor comprises an area water monitor for monitoring water flowing to an area within with industrial process.

48 A remote water monitoring system according to claim 44, wherein the at least one monitor comprises a sub-process water monitor for monitoring water flowing to sub-process within with industrial process.

49 A system configured for monitoring water usage by an industrial process, the system comprising:
a Water Monitoring Module acquiring water usage information, the water usage information associated with water used by the industrial process;
a memory storage device storing the acquired water usage information; and
a processor calculating water usage for the industrial process based upon the acquired water usage information.

50 A computer program for monitoring water usage from industrial and residential facilities, the computer program comprising the steps of:
communicating with a communications network and acquiring water usage information, the water usage information acquired in real time; and
reporting water usage based upon the acquired water usage information.

51 A computer program for monitoring water usage according to claim 50, further comprising the step of displaying the acquired water usage information.

52 A computer program for monitoring water usage according to claim 50, further comprising the step of predicting future water usage based upon the acquired water usage information.

53 A computer program for monitoring water usage according to claim 50, further comprising the step of communicating predicted future water usage information to at least one computer coupled to the communications network, the predicted water usage information based upon the acquired water usage information.

54 A computer program for monitoring water usage according to claim 50, further comprising the step of formatting the acquired water usage information to the requirements of a regulatory agency.

55 A computer program for monitoring water usage according to claim 54, further comprising the step of communicating formatted water usage information to at least one computer coupled to the communications network.

56 A computer program for monitoring water usage according to claim 54, further comprising the step of communicating formatted water usage information to a regulatory agency.

57 A computer program for monitoring water usage according to claim 50, further comprising the step of comparing the acquired water usage information to historical water usage information.

58 A computer program for monitoring water usage according to claim 50, further comprising the step of communicating historical water usage information to at least one computer coupled to the communications network.
